(19) United States
(12) Patent Application Publication
(10) Pub. No.: US 2019/0204274 A1
(43) Pub. Date: Jul. 4, 2019

(54) Systems and Methods for Improved Contraband Detection

(71) Applicant: Rapiscan Systems, Inc., Torrance, CA (US)

(72) Inventors: Gary A. Eiceman, Las Cruces, NM (US); Marlen R. Menlyadiev, Nashua, NH (US); Hartwig Schmidt, Tewksbury, MA (US); Stefan R. Lukow, Windham, NH (US); Peter Fowler, Las Cruces, NM (US); Gyoungil Lee, Las Cruces, NM (US)

(21) Appl. No.: 16/222,971

(22) Filed: Dec. 17, 2018

Related U.S. Application Data
(60) Provisional application No. 62/611,313, filed on Dec. 28, 2017.

(51) Int. Cl. G01N 27/62; H01J 49/00; H01J 49/04

(52) U.S. Cl. CPC G01N 27/624; H01J 49/0409; H01J 49/0031

(57) ABSTRACT

A system for multi-stage differential mobility spectrometer (multi-stage DMS) and the method of operating and using the same are described. Ions produced in an ionization source are introduced into the separation region of multi-stage DMS, which includes at least two DMS stages. Each DMS stage is configured to generate separation and compensation fields to characterize, separate, or select ion species. The separation region further includes ion alteration stages which are placed between various adjacent stages of multi-stage DMS. Alteration of ions can be both chemical and physical. Ions which are separated, altered, and selectively passed by all DMS stages of multi-stage DMS are then measured or further characterized by the Faraday plate detectors or a mass spectrometer.

### CROSS REFERENCE

The present specification relies on, for priority, U.S. Patent Provisional Application No. 62/611,313 entitled “Dual Stage Differential Mobility Spectrometer”, filed on Dec. 28, 2017, which is incorporated by reference herein in its entirety.

### FIELD

The present specification relates to systems for Differential Mobility Spectrometry (DMS). More particularly, the present specification relates to multi-stage DMS analyzers and methods of operation and use.

### BACKGROUND

Ion mobility methods, such as Differential Mobility Spectrometry (DMS), are used in chemical measurements and are based on formation of ions derived from a sample and the characterization of these ions in electric fields and supporting gas atmospheres. Supporting atmospheres may include air, nitrogen, and combinations of gases including hydrogen and helium at pressures ranging from a few torr to ambient pressure. The characterization of gas ions in electric fields is based on speed of ion swarms and establishes a measure of the identity of substances in a sample. Substance identities then may be used to extract the information on the composition of a sample.

In DMS, ion characterization occurs in an oscillating asymmetric electric field through differences, at extremes of the applied field, in the ion mobility coefficients that become field-dependent in strong fields. In a DMS measurement, ions are carried in a flow of gas through the oscillating field, also known as the separating field and often exceeding 10,000 V/cm, that is established between two parallel plates with a narrow gap or channel for gas and ion flow. Field-dependent mobilities create off-axis displacement of ions and a correcting field is applied to reposition ions to the center of the gap where they pass to a Faraday plate, mass spectrometer, or other detector to record a signal. A scan of the correcting or compensation field produces a measure of all ions in the DMS analyzer, a differential mobility spectrum, which provides a chemical measurement of a sample.

Two structures have been employed for the characterization of gas ions in strong asymmetric electric fields based on principles of field dependent mobility. These have included structures with curved surfaces and can be found in technology embodiments termed Field Asymmetric Ion Mobility Spectrometry (FAIMS) and with planar surfaces as found in embodiments termed differential mobility spectrometry (DMS). Differences between DMS and FAIMS are significant even while similarities exist, such as, applied waveforms to generate electric fields, overall concept of ion characterization in two electric fields (separation and compensation fields), and methods of controlling parameters for measurements. Both DMS and FAIMS are considered ion filters and not ion spectrometers.

The sweep of compensation field, or voltage, required in small DMS analyzers is approximately 0.5 seconds, although 1 to 3 seconds provides the best quality in DMS spectra. Chemical information on a sample can be obtained from dispersion plots where DMS spectra are obtained repeatedly as the separation field is changed. When the change in separation field is large enough, a pattern for field dependent mobility becomes apparent providing additional chemical information on a substance with a DMS analyzer. The time to simultaneously scan compensation fields over a range of separation fields is intrinsically slower than obtaining a single DMS spectrum and may require 60 seconds or more.

The principles of DMS briefly summarized here are very different from those of another ion mobility method called Differential Mobility Analysis or Analyzer (DMA). Unlike DMS, where differences between high and low field mobilities of ions are used for ion characterization and separation, DMA operates based on low field mobility separation of ions only. Differences in principles of operation translate into differences in practical implementation. While DMS instruments can be easily miniaturized, technology for DMA is larger and more complex.

Even though miniaturized analyzers based on DMS can provide high versatility and high sensitivity, the specificity or selectivity of response is still somewhat limited for DMS analyzers operated in air at ambient pressure. The selectivity of response is governed by operating parameters, drift tube designs, and ion behavior producing spectra with relatively broad peak widths.

Single stage DMS analyzers operating at ambient conditions have limited resolving power especially for substances above 200 amu. Ions from substances with such molecular masses tend to cluster at compensation voltages near 0 V leaving little analytical resolution both from other substances of interest and from the interferences. As the number of contraband substances to be detected increases, such behavior of single stage DMS systems may have detrimental effects on alarm statistics and leads to high False Alarm Rates (FARs).

Selectivity of response is also governed by differences between peak maxima in DMS spectra. Since peaks for ions with molar masses of 150 Da or greater trend toward compensations fields near zero, significant overlap of ion peaks occurs in DMS spectra, and response from a specific substance is difficult or impossible to distinguish from other substances. When analyzing mixtures, and especially complex mixtures, this produces a loss in selectivity of response or false alarms. When DMS analyzers are used in measurements of toxic or dangerous samples, high FARs decrease the value of or confidence in a measurement.

Efforts to improve selectivity of response in DMS with analyzers operated in air at ambient pressure have included chemical modifiers, small volatile substances, added into the supporting gas atmosphere to change field dependent mobility coefficients for ions. The modifier is added throughout the gas including the ion source, affecting ionization chemistry, and sometimes interferes with a measurement.

Another approach to improve selectivity of response has been the selection of a separation field which provides best peak position, as governed by the dispersion plot for an ion. This necessitates pre-knowledge of the ion and interferences.

There have been two approaches to increasing the limited resolving power of single stage DMS or adding analytical value beyond the core differential mobility spectra. In the first approach, sometimes included with DMS in hyphenated instruments, reagents have been added into the DMS analyzer. This created changes in the ion's environment (without chemical alteration of ions) with effects on differential mobility of ions and sometimes shifts in compensation voltages allowing better resolution of ion peaks. The second approach is to combine single stage DMS analyzers with other instruments, for example, as detectors with chromatographs where compounds are preseparated prior to their detection, and as prefilters with mass spectrometers and mobility spectrometers. The authors of present specification have previously combined two DMS units into tandem differential mobility spectrometer (DMS/DMS). It was found with DMS/DMS system that filtering capabilities of DMS with two stages without chemical or physical altering of ions may be insufficient with increasingly complex mixtures such as those found in contraband detection

Advances in selectivity of response are needed with DMS analyzers of current levels of basic performance, peak widths and dispersion plots, to provide greater confidence in detecting explosives, narcotics, or other substances of interest, especially in complex mixtures. This should be achieved with a DMS system that is low power, compact, hand-held or portable, and at a reasonable cost with operation at ambient pressure in air atmosphere.

### SUMMARY

The following embodiments and aspects thereof are described and illustrated in conjunction with systems, tools and methods, which are meant to be exemplary and illustrative, not limiting in scope.

In some embodiments, the present specification discloses a differential mobility spectrometer (DMS). The DMS includes a chamber and a detector. A flow of ions travels through the chamber from a first end toward a second end opposite the first end. The chamber includes a first DMS stage configured to generate a first compensated asymmetric electric field therein to separate a first mixture of ion species from the flow of ions, and a second DMS stage configured to generate a second compensated asymmetric electric field therein to separate a second mixture of ion species from the first mixture of ion species exiting the first DMS stage. The detector is disposed at the second end of the chamber and is configured to collect a charge from the second mixture of ion species as they exit the second DMS stage, and to generate a characteristic signal representative of the second mixture of ion species incident on the detector.

In some embodiments, the present specification discloses a method of conducting differential mobility spectrometry. The method includes receiving a flow of a plurality of ions at a first differential mobility spectrometer (DMS) stage. The method includes generating a first compensated asymmetric electric field within the first DMS stage to separate a first mixture of ion species from the flow of the plurality of ions, the first compensated asymmetric electric field corresponding to the first mixture of ion species. The method includes receiving the first mixture of ion species at a second DMS stage. The method includes generating a second compensated asymmetric electric field within the second DMS stage to separate a second mixture of ion species derived from the first mixture of ion species and received at the second DMS stage, the second compensated asymmetric electric field corresponding to the second mixture of ion species. The method includes collecting a charge from the second mixture of ion species incident on a detector.

In some embodiments, the present specification discloses a differential mobility spectrometer (DMS) that includes an ion source configured to receive a sample of a substance of interest and generate ions therefrom. The DMS includes a chamber comprising a first and second end opposite the first end. The first end is coupled to the ion source. The chamber defines a drift region through which a flow of the ions generated by the ion source travel. The chamber further includes a plurality of DMS stages, each DMS stage of the plurality of DMS stages including first and second electrodes defining an analytic region there between. Each DMS stage is configured to generate a respective compensated asymmetric electric field corresponding to a mixture of ion species, and separate selected ion species from the flow of the ions through the chamber. The DMS includes a detector coupled to the chamber at the second end and configured to collect a charge from the selected ions that pass through all of the plurality of DMS stages. The detector is further configured to generate a characteristic signal representative of the selected ions incident on the detector.

In some embodiments, the present specification discloses a multi-stage differential mobility spectrometer (DMS), comprising a chamber through which a flow of ions travels from a first end toward a second end opposite the first end, said chamber comprising: a plurality of DMS stages, comprising: a first DMS stage configured to generate a first compensated asymmetric electric field therein to separate a mixture of ion species from the flow of ions generated in an ion source; a second DMS stage configured to generate a second compensated asymmetric electric field therein to separate a second mixture of ion species resulting from filtering of some ion species by the first DMS stage; at least one detector disposed at the second end of said chamber, said detector configured to: collect a charge of ion species exiting from a last DMS stage; and generate a characteristic signal representative of ion species exiting the last DMS stage and incident on said detector.

Optionally, the multi-stage DMS further comprises an ionization source disposed at the first end of said chamber and configured to: receive a sample of a substance of interest; generate ions from the sample; and direct the generated ions into the first DMS stage of said multi-stage DMS.

Optionally, said ionization source is further configured to: receive at least one of a reagent and a dopant; and generate the ions from the sample and at least one of a reagent and a dopant.

Optionally, said chamber further comprises at least one alteration stage disposed between any pair of adjacent DMS stages, said alteration stage configured to: receive the pre-filtered ion population from the preceding DMS stage of the adjacent DMS pair in said chamber; perform at least one of a chemical and a physical alteration on the ion population, thereby producing altered ions from the ion population pre-filtered by at least one preceding DMS stage; and direct the altered ions into said subsequent DMS stage of said DMS pair within said multi-stage DMS.

Optionally, said alteration stage comprises at least one fragmentor configured to dissociate ion populations pre-filtered by preceding DMS stages. Optionally, said alteration stage comprises at least one mixing chamber into which a predetermined concentration of a dopant is injected to a mixture of ions emerging from the DMS stage preceding a mixing chamber.

Optionally, said first DMS stage comprises first and second electrodes that define an analytic gap there between and through which the flow of ions passes, said first and second electrodes configured to create the first compensated asymmetric electric field, including a separation field defined as a function of a separation voltage applied transversely on at least one of said first and second electrodes, and a compensation field defined as a function of a compensation voltage applied transversely on at least one of said first and second electrodes.

Optionally, the multi-stage DMS further comprises voltage generators operated by a controller and coupled to corresponding electrodes of respective DMS stages, said voltage generators configured to: generate waveforms with changing amplitude such that characteristic oscillation between low and high field strength is realized; and generate at least one compensation voltage signal that sweeps over at least one of a predetermined range of compensation voltages and a set compensation voltage corresponding to the compensation field for a mixture of ion species.

Optionally, the multi-stage DMS is configured to be integrated with at least one of an ion mobility spectrometry (IMS) apparatus and an ion trap mobility spectrometry (ITMS) apparatus, wherein the IMS and ITMS apparatuses may be placed before or after the multi-stage DMS and allow for additional ion characterization in an integrated apparatus.

Optionally, the multi-stage DMS is configured to be integrated with a mass spectrometer of a selected type, wherein the mass spectrometer is placed after the multi-stage DMS and allows for additional characterization of ions emerging from the last stage of the multi-stage DMS.

Optionally, the multi-stage DMS is configured to be integrated with a separation apparatus based on at least one of gas and liquid chromatography methods or capillary electrophoresis, said separation apparatus is configured to perform sample pre-fractionation and is placed in front of multi-stage DMS.

In some embodiments, the present specification discloses a method of conducting multi-stage differential mobility spectrometry, said method comprising: receiving a flow of a plurality of ions at a first differential mobility spectrometer (DMS) stage; generating a first compensated asymmetric electric field within the first DMS stage to separate a first population of ion species from the flow of the plurality of ions, the first compensated asymmetric electric field corresponding to the first stage of selecting ion species; receiving the selected ion species at a second DMS stage; generating a second compensated asymmetric electric field within the second DMS stage to separate ion species selected in the first DMS stage, the second compensated asymmetric electric field corresponding to the second stage of selecting ion species; and collecting a charge of ion species emerging from a last DMS stage of multi-stage DMS on detectors.

Optionally, the method further comprises generating a characteristic signal representative of multiple steps of ion filtering in different DMS stages of a multi-stage DMS chamber.

Optionally, the method further comprises performing at least one of a chemical alteration and a physical alteration on the selected population of ion species after the selected population of ion species exit a selected DMS stage and before the selected population of ion species enters the subsequent DMS stage. Still optionally, performing at least one of a chemical alteration and a physical alteration comprises introducing a predetermined concentration of a dopant to the selected population of ion species. Still optionally, performing at least one of a chemical alteration and a physical alteration comprises dissociating the first selected population of ion species.

Optionally, the generating the first compensated asymmetric electric field within a stage of multi-stage DMS comprises: applying a separation voltage across first and second electrodes of the DMS stage to generate a separation field; and applying a compensation voltage across the first and second electrodes to generate a compensation field that augments the separation field, thereby generating the first compensated asymmetric electric field.

Optionally, applying a compensation voltage across the first and second electrodes comprises sweeping a voltage applied across the first and second electrodes through a range of compensation voltages corresponding to the specific characteristics of ion species present in this particular stage of a multi-stage DMS.

Optionally, the flow of the plurality of ions includes the selected ion species and may include at least one population of unselected ion species.

Optionally, generating the first compensated asymmetric electric field within the first DMS stage further comprises directing the first selected population of ion species through a selected DMS stage toward the subsequent DMS stage along a path of the flow of the plurality of ions. Still optionally, generating the first compensated asymmetric electric field within the selected DMS stage further comprises displacing the at least one unselected ion species in a direction transverse to the flow of the plurality of ions and toward one of a first electrode and a second electrode of the selected DMS stage.

Optionally, the method further comprises neutralizing at least one unselected ion species upon contact with one of the first electrode and the second electrode of the selected DMS stage.

The aforementioned and other embodiments of the present specification shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 is a block diagram of an exemplary multi-stage differential mobility spectrometer (multi-stage DMS), in accordance with some embodiments of the present specification;

FIG. 2 is schematic diagram of the DMS shown in FIG. 1;

FIG. 3 is a flow diagram of an exemplary method of conducting differential mobility spectrometry using the multi-stage DMS shown in FIG. 1 and FIG. 2, in accordance with some embodiments of the present specification;

FIG. 4 is a plot of intensity in arbitrary units versus compensation voltage (V) of interference, ethylene glycol dinitrate (EGDN), and fragment of EGDN for explosives detection with the fragmentor, of the multi-stage DMS shown in FIG. 1 and FIG. 2, enabled and disabled, in accordance with some embodiments of the present specification;

FIG. 5 is a plot of intensity in arbitrary units versus compensation voltage (V) of Fentanyl, THC, and Cannabinol for narcotics detection with different reagent regions of the multi-stage DMS shown in FIG. 1 and FIG. 2, in accordance with some embodiments of the present specification;

FIG. 6 illustrates an exemplary process for determining filtering conditions for different DMS stages, in accordance with some embodiments of the present specification;

FIG. 7 illustrates an exemplary process of determining whether selective detection can be achieved by varying parameters within each DMS stage, in accordance with some embodiments of the present specification; and,

FIG. 8 illustrates another exemplary process for implementing multi-stage DMS in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present specification is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present specification.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

Embodiments of the DMS systems and methods described herein provide a multi-stage DMS system. More specifically, ions from analytes such as, for example, explosives, narcotics, or other substances of interest, are characterized using two or more successive stages having differing electric field conditions to carry out separation and characterization. In certain embodiments, ions are chemically or physically altered between stages. Such alterations may include, for example, charge exchange, cluster formation, and fragmentation. In other embodiments, ions are not chemically or physically altered between stages.

It should be appreciated that the presently disclosed inventions have numerous distinct benefits over the prior art. First, in the preferred embodiments of the multi-stage DMS system, there are 2 or more DMS stages and there are no detectors after a stage until after the last stage. Therefore, for a system with n stages, there are no detectors after any of stages 1 through n−1. There is only a detector after stage n. Second, only pre-selected ions, not uncontrolled mixtures of neutrals, pass from preceding to subsequent DMS stages. Third, chemical and/or physical modifications or alterations of ions, not neutral molecules are carried out between different stages of our multi-stage DMS systems. Fourth, an ion filter is used (hence a DMS), not a dispersive spectrometer like IMS, thereby allowing far greater flexibility in ion selection in different stages of multi-stage DMS. Finally, DMS is more amenable to miniaturization and low residence times in each DMS stage (1-3 ms) which allow for more than 2 DMS stages to be combined into multi-stage DMS while also preserving required ion intensity that may become problematic with multi-stage IMS.

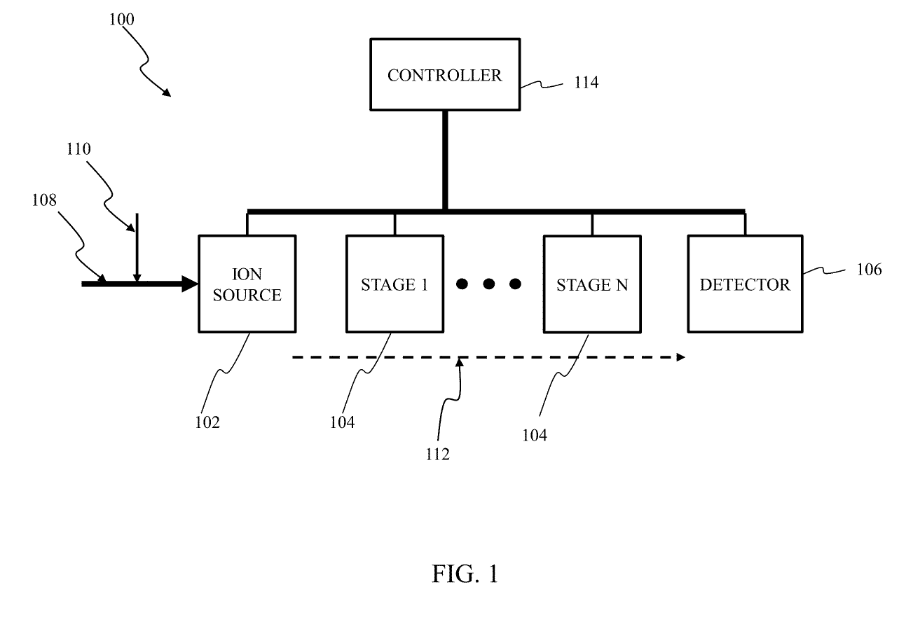

FIG. 1 is a block diagram of an exemplary DMS system 100. DMS system 100 includes an ion source 102, N DMS stages 104, and a detector 106. A gas flow 108 containing a sample enters ion source 102 and, in certain embodiments, is mixed with a dopant or reagent 110. In various embodiments, the sample enters through a sample inlet such as but not limited to one of Gas Chromatography (GC), vapor preconcentrator, cartridge, and desorber. Ion source 102 generates ions 112 from gas flow 108. Ions 112 flow from ion source 102 toward detector 106 through successive DMS stages 104, from one side to other, as illustrated in FIG. 1. Ions 112 undergo separation and characterization as they traverse through each DMS stage 104. Each of N DMS stages 104 utilizes a distinct electric field, sometimes referred to as a compensated asymmetric electric field, to carry out the separation and characterization.

DMS system 100 includes a controller 114 communicatively coupled to ion source 102, N DMS stages 104, and detector 106. Controller 114 is configured to control operation of DMS system 100, including, for example, controlling the respective compensated asymmetric electric fields in each of N DMS stages 104. Controller 114 may include, for example, one or more signal generators for generating separation voltage signals and compensation voltage signals. Controller 114 may further include one or more amplifiers for the separation voltage signals and compensation voltage signals, and for characteristic signals generated by detector 106.

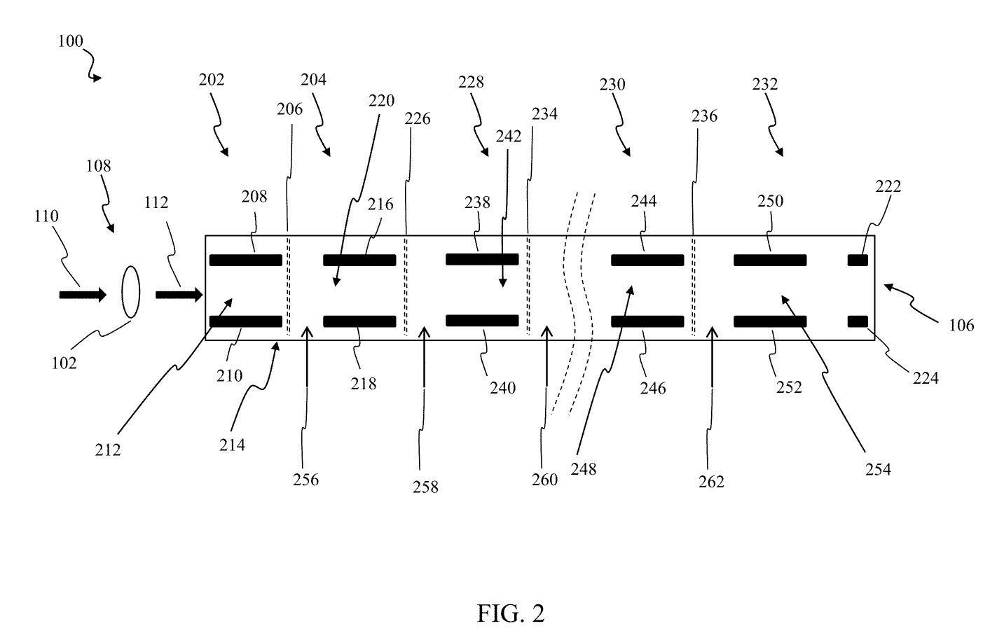

FIG. 2 is a schematic diagram of DMS system 100 shown in FIG. 1, including successive DMS stages 202, 204, 228, 230, and 232 disposed between ion source 102 and detector 106. DMS system 100 further includes alteration stages 206, 226, 234, and 236 disposed between DMS stages 202 and 204, 204 and 228, 228 and 230, and 230 and 232, respectively, and configured to perform one or more chemical or physical alteration on ions 112 passing from DMS stages 202, 204, 228, 230, and 232 into each successive DMS stage 202, 204, 228, 230, and 232.

DMS stage 202 includes electrodes 208 and 210 defining an analytical gap 212 there between and within a chamber, or drift tube 214. Controller 114 controls DMS stage 202 to generate an asymmetric electric field. The asymmetric electric field includes a separation field produced by a selected separation voltage, Sv, oscillating between a high strength electric field and a low strength electric field and applied across electrodes 208 and 210. Generally, the separation voltage oscillates at a frequency between 100 kilohertz (kHz) and 25 megahertz (MHz). For example, in certain embodiments, the separation voltage varies from one to three MHz. Further, the separation field generally has a strength between 1000 volts/centimeter (V/cm) to 60,000 V/cm. In addition to the separation field, a DC compensation voltage, Cv, is applied across electrodes 208 and 210, i.e., the separation field co-exists with a compensation field defined as a function of the compensation voltage. The compensation voltage may be fixed or varied, i.e., swept through a range of Cv, and further correlates to species of ions selected for characterization by DMS stage 202 using the particular combination of separation voltage and compensation voltage, i.e., a compensated asymmetric electric field. In embodiments, the Cv has a strength between −50V and +50V.

Ions 112 flowing through drift tube 214 and analytical gap 212 are displaced transversely, i.e., toward electrodes 208 or 210, in their path by the oscillating electric field. A given ion species displaces transversely as a function of the difference in mobility of that ion species under the high strength electric field versus the low strength electric field. Application of the compensation voltage offsets the transverse displacement for that species of ion. The separation voltage and compensation voltage are selected such that a selected ion species will have a zero or a near zero net transverse displacement through analytical gap 212 under the compensated asymmetric electric field. Selection of a compensation voltage sweep, rather than a fixed compensation voltage, enables passage of a spectrum of ion species. Such ions, e.g., a spectrum of ion species, or a mixture of ions, pass through DMS stage 202 and, in certain embodiments, are processed by alteration stage 206 before passing into DMS stage 204. This flow of ions 112 is referred to herein as line-of-sight operation. All other ions experience a net displacement toward electrode 208 or 210 and are ultimately neutralized upon collision with the electrodes 208 and 210. Neutralized ions are lost from measurement.

Field Asymmetric Ion Mobility Spectrometry (FAIMS) systems (not illustrated) operate on the same principles as DMS system 100 with the exception that FAIMS systems do not have field homogeneity. In DMS system 100 ions 112 flow through uniform electric fields that are not curved. Consequently, ion 112 motion through the structure shows a regular behavior of ions 112 between the surfaces of drift tube 214. While there is a capability to separate ions 112 based on differences in mobility between the field extremes, no other dependencies exist within DMS system 100. Increases in separation field necessitate an increased compensation field and a secondary impact arises with ion losses near the edges of the gap formed by the surfaces of drift tube 214. Thus, increased separation voltage results in reduced ion intensity. When the electric field is removed from DMS system 100, ion flux is at its maximum without ion discrimination. In FAIMS systems, which have curved surfaces, ion field lines are uneven or not uniform due to differences in radii of the inner and outer surfaces. The curved field gradients or uneven ion field lines result in a second ion behavior superimposed on that of mobility differences. Ion selection by differences in mobility coefficients as described above occurs, and for a particular combination of separation and compensation fields, ions are focused inward in the gap between surfaces. This effect increases with increased separation field. When the electric field is removed from curved surfaces, ion transmission has historically been lost although new progress may permit ion transmission with only some loss.

Selected ion species or mixtures of species, of ions 112 flowing through drift tube 214, that are passed through DMS stage 202 are processed by alteration stage 206. Alteration stage 206 is configured to apply one or more chemical or physical alteration to the selected ions, such as, for example, charge exchange, cluster formation, and dissociation, i.e., fragmentation. Dissociation or fragmentation may be achieved using thermal or electric energy. In some embodiments, the fragmentation field may vary within 1,000 V/cm and 60,000 V/cm. Fragmentation field waveforms such as sinusoidal, square, or asymmetric waves or combinations of which may be used. In certain embodiments, alteration stage 206 may include a mixing chamber into which additional dopants 256 at specific concentrations are injected, or mixed, into the ion flow. Ions processed by alteration stage 206, i.e., altered ions, are then directed into DMS stage 204.

The selected ions pass from DMS stage 202 and alteration stage 206 directly into DMS stage 204. Selected ions from DMS stage 204 and alteration stage 226 and each successive DMS stage 228, 230, and 232 and alteration stage 234 and 236 flow directly into successive DMS stages 228, 230, and 232. In certain embodiments, alteration stages 226, 234, and 236 may include a mixing chamber into which additional dopants 258, 260, and 262, respectively, at specific concentrations are injected, or mixed, into the ion flow. In embodiments, the dopants may include one or more of alcohols, aldehydes, ketones, halogenated hydrocarbons, acetonitrile, ammonia, electron donating compounds, and electron accepting compounds. DMS stages 204, 228, 230, and 232, include electrodes 216 and 218, 238 and 240, 244 and 246, and 250 and 252, respectively, which define analytic regions 220, 242, 248, and 254, respectively. DMS stages 204, 228, 230, and 232 operate in the same manner as DMS stage 202 to generate a compensated asymmetric electric field generated by a separation voltage and a compensation voltage applied across electrodes 216, 218, 238, 240, 244, 246, 250, and 252. The compensated asymmetric electric fields for DMS stages 204, 228, 230, and 232 are distinct from those of other DMS stages 202, 204, 228, 230, and 232. In alternative embodiments, DMS system 100 includes one or more additional DMS stages operating with respective compensated asymmetric electric fields that are further distinct from the compensated asymmetric electric fields of DMS stages 202, 204, 228, 230, and 232. Distinct electric fields may be achieved by utilizing different separation voltages, different fixed compensation voltages, different compensation voltage sweeps, or any combination thereof.

Selected ions, of ions 112 flowing through drift tube 214, which pass through all DMS stages 202, 204, 228, 230, and 232 are collected by detector 106 having a positive electrode 222 and a negative electrode 224. The ions incident on detector 106 deposit their respective charges on detector 106. Detector 106 generates a characteristic signal as a result of the potential developed across electrodes 222 and 224. Controller 114 receives the characteristic signal from detector 106.

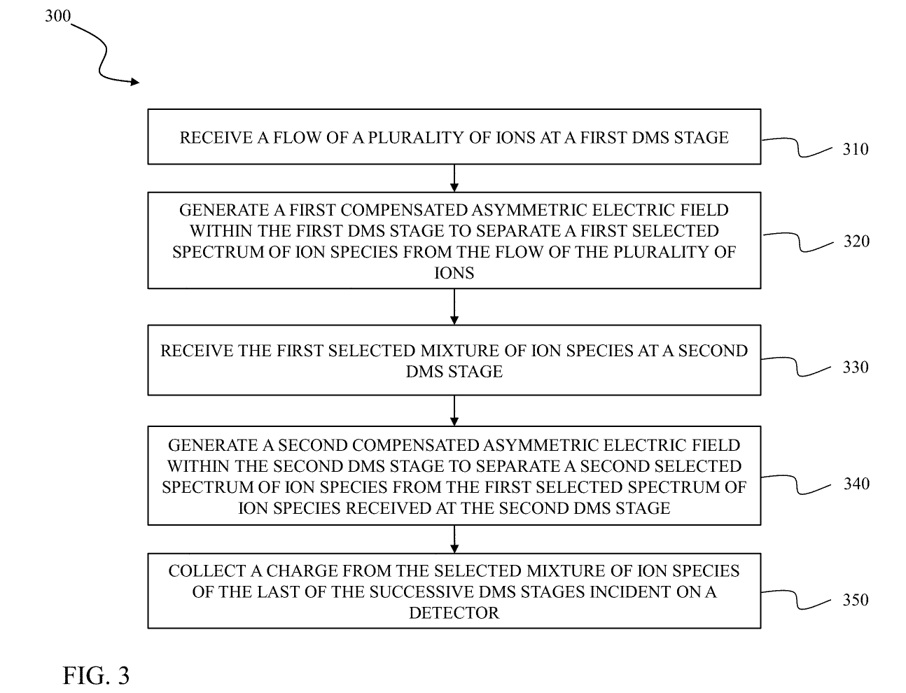

FIG. 3 is a flow diagram of an exemplary method 300 for conducting differential spectrometry using DMS system 100, shown in FIG. 1 and FIG. 2. Generally, a gas flow 108 including a sample of a substance of interest is introduced to ion source 102. Ion source 102 generates a plurality of ions 112 from the sample. In certain embodiments, a dopant or reagent 110 is also introduced with gas flow 108 and ion source 102 generates the plurality of ions 112 from a mixture of the sample and dopant or reagent 110.

Referring simultaneously to FIGS. 1, 2, and 3, at 310, gas flow 108 is received within system 100. In embodiments, the flow rate may vary from 50 mL/min to 5000 mL/min. The gas includes a flow of a plurality of ions 112 at first DMS stage 202. At 320, first DMS stage 202 generates a first compensated asymmetric electric field within first DMS stage 202 to separate a first mixture of ion species from gas flow 108. More specifically, the first compensated asymmetric electric field is generated transversely between first electrode 208 and second electrode 210 in analytic gap 212. The first compensated asymmetric electric field corresponds to the first mixture of ion species.

Generally, gas flow 108 includes the first mixture of ion species and at least one unselected ion species in the plurality of ions 112. In generating the first compensated asymmetric electric field, first DMS stage 202 directs the first mixture of ion species through first DMS stage toward second DMS stage 204 along a path of gas flow 108. Conversely, the first compensated asymmetric electric field displaces the at least one unselected ion species in a direction transverse to gas flow 108 and toward one of first electrode 208 and second electrode 210. Accordingly, the first mixture of ion species passes through first DMS stage 202, while unselected ion species are neutralized upon contact with one of first electrode 208 and second electrode 210, i.e., the first mixture of ion species is separated from unselected ion species.

First DMS stage 202 generates the first compensated asymmetric electric field by applying a separation voltage across first electrode 208 and second electrode 210 to generate a separation field. A compensation voltage is also applied across first electrode 208 and second electrode 210 to generate a compensation field that compensates for the effect of the separation field, thereby generating the first compensated asymmetric electric field. In certain embodiments, the compensation voltage is a fixed voltage that corresponds to a selected ion species. In other embodiments, the compensation voltage is applied as a sweep through a range of compensation voltages, where the range of compensation voltages corresponds to a mixture of ion species, e.g., the first mixture of ion species. In embodiments, the compensation voltage lies within a range of −50V to +50V.

At 330, the first mixture of ion species separated from unselected ion species by first DMS stage 202 is received from first DMS stage 202 by second DMS stage 204. At 340, similar to first DMS stage 202, second DMS stage 204 generates a second compensated asymmetric electric field to separate a second mixture of ion species from the first mixture of ion species received from first DMS stage 202 at second DMS stage 204. The second compensated asymmetric electric field corresponds to the second mixture of ion species.

Generally, the first mixture of ion species in gas flow 108 that passes through first DMS stage 202 into second DMS stage 204 includes the second mixture of ion species and at least one other unselected ion species. In generating second compensated asymmetric electric field, second DMS stage 204 and successive DMS stages 228, 230, and 232 direct respective mixtures of ion species through DMS stages 204, 228, 230, and 232 toward detector 106 along a path of gas flow 108. Conversely, successive compensated asymmetric electric fields displace the at least one other unselected ion species in a direction transverse to gas flow 108 and toward one of first electrodes 216, 238, 244, and 250 and second electrodes 218, 240, 246, and 252. Accordingly, the mixture of selected ion species pass through all DMS stages 202, 204, 228, 230, and 232, while the unselected ion species are neutralized upon contact with one of first electrodes 216, 238, 244, and 250 and second electrode 218, 240, 246, and 252, i.e., the mixture of ion species is separated from the first mixture of ion species in gas flow 108.

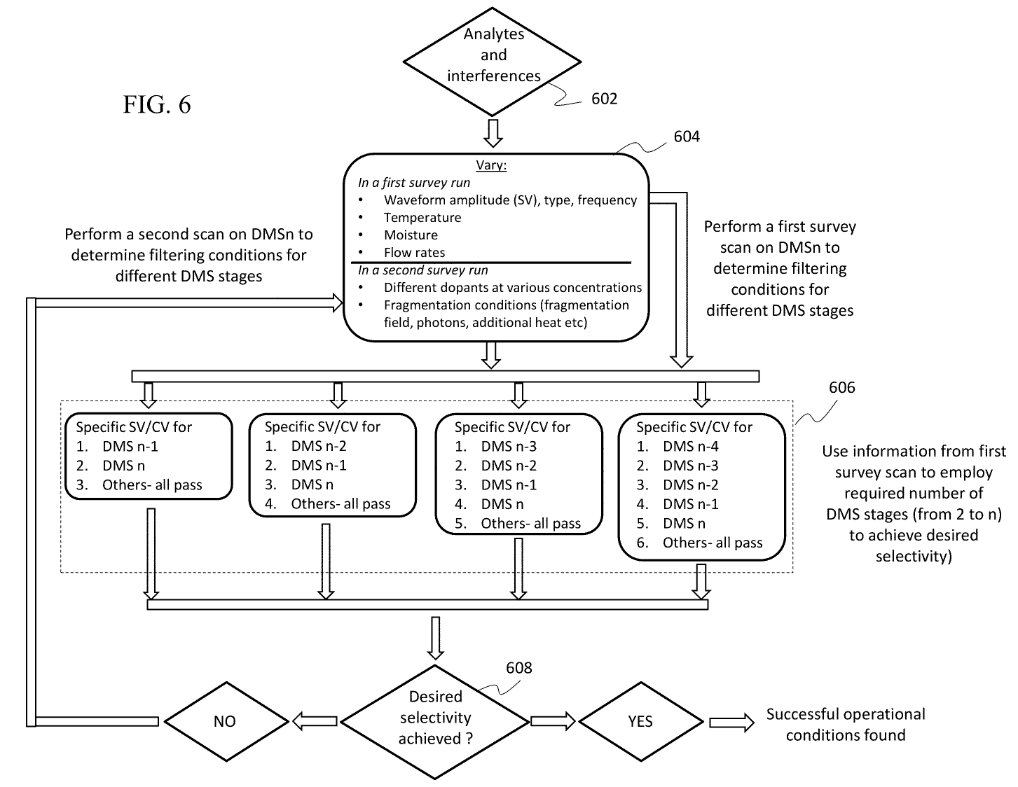

As in first DMS stage 202, successive DMS stages 204, 228, 230, and 232 generate the successive compensated asymmetric electric fields by applying separation voltages across first electrodes 216, 238, 244, and 250 and second electrodes 218, 240, 246, and 252 to generate separation fields. Compensation voltages are also applied across first electrodes 216, 238, 244, and 250 and second electrodes 218, 240, 246, and 252 to generate compensation fields that augment the separation fields, thereby generating the successive compensated asymmetric electric fields. In certain embodiments, the compensation voltages are fixed voltages that correspond to a selected ion species. In other embodiments, the compensation voltages are applied as a sweep through a range of compensation voltages, where the range of compensation voltages corresponds to a mixture of ion species, e.g., the second mixture of ion species. Notably, the first compensated asymmetric electric field utilized in first DMS stage 202 is different from the second compensated asymmetric electric field utilized in second DMS stage 204 and all successive compensated asymmetric electric fields utilized in successive DMS stages 228, 230, and 232. FIG. 6, described subsequently, illustrates an exemplary process of determining filtering conditions for the different DMS stages.

In certain embodiments, method 300 includes receiving ions in gas flow 108 at additional DMS stages disposed in series with, i.e., in light-of-sight with, DMS stages 202, 204, 228, 230, and 232. In such embodiments, method 300 further includes generating respective compensated asymmetric electric fields in the additional DMS stages to further separate, or filter, selected ions in gas flow 108 as it passes through drift tube 214 toward detector 106.

In certain embodiments, method 300 includes alteration stages 206, 226, 234, and 236 performing at least one of a chemical alteration and a physical alteration on the first mixture of ion species after the first mixture of ion species exits first DMS stage 202, 204, 228, and 230 and before entering successive DMS stage 204, 228, 230, and 232. Such chemical alterations or physical alterations may include cluster formation, charge exchange, dissociation or fragmentation. In certain embodiments, the chemical alteration or physical alteration includes introduction of a predetermined concentration of a dopant 256, 258, 260, and 262 to gas flow 108 to mix with the first mixture of ion species before the ions enter successive DMS stages 204, 228, 230, and 232. In various embodiments, the dopants may be one more of alcohols, aldehydes, ketones, halogenated hydrocarbons, acetonitrile, ammonia, electron donating compounds, electron accepting compounds, or any other. In some embodiments, the dopants are introduced at a concentration of 1 parts per billion (ppb). In some embodiments, gas modifier concentration of 10% volume/volume (v/v) is used for chemical or physical alterations. In some embodiments temperature is used for the desired chemical or physical alterations. In some embodiments, temperature in a range of −20° C. to +150° C. is used. In some embodiments, electric fields, photons (light), or moisture, is used for the desired chemical or physical alterations.

In embodiments where additional DMS stages are utilized, additional alteration stages may also be disposed between any two sequential DMS stages, similar to alteration stage 206 disposed between first DMS stage 202 and second DMS stage 204 and alteration stages 226, 234, and 236 disposed between respective DMS stages 204, 228, 230, and 232. Such alteration stages may be configured to perform one or more of a chemical alteration and a physical alteration on the successive mixture of ion species that exits previous DMS stage 202, 204, 228, 230, and 232 before the successive mixture of ion species enters the successive DMS stage to undergo further separation and characterization.

At 350, a charge from the mixture of ion species of the last of the successive DMS stages 232 incident on detector 106 is collected. More specifically, as selected ions that pass through all DMS stages 202, 204, 228, 230, and 232 contact detector 106, the selected ions, e.g., the mixture of ion species of the last successive DMS stage 232, deposit respective charges on electrodes 222 and 224 of detector 106. Detector 106 generates a characteristic signal representative of the mixture of ion species exiting the last of the successive DMS stages.

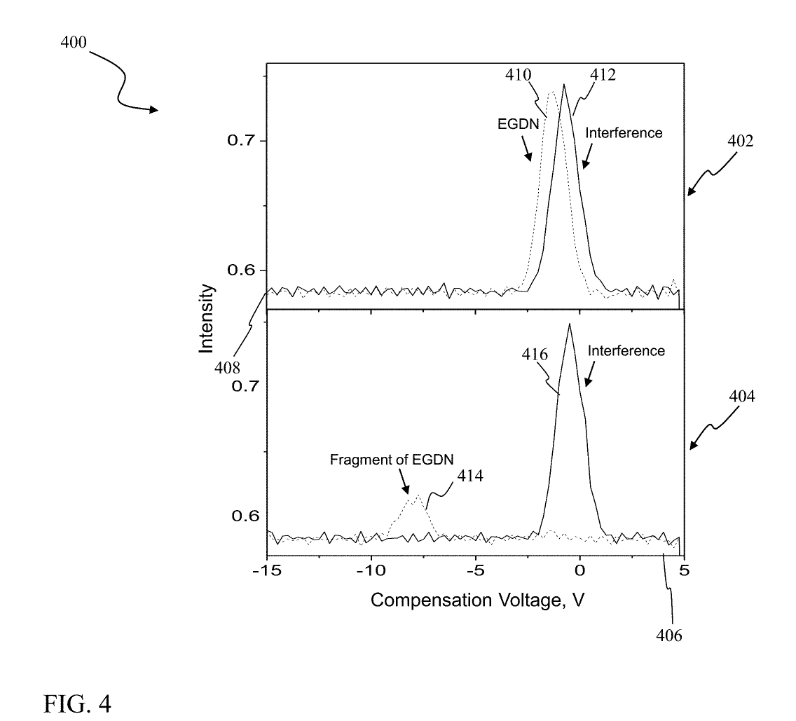

FIG. 4 is a graph 400 of intensity, expressed in arbitrary units, versus compensation voltage, expressed in Volts (V), for explosives detection in, for example, exemplary DMS system 100 shown in FIG. 1 and FIG. 2. Intensity versus compensation voltage is graphed, for example, using a collected charge from the mixture of ion species of the last DMS stage of DMS system 100 incident on detector 106. Alteration stages 206, 226, 234, and 236 between DMS stages 202, 204, 228, 230, and 232 may include fragmentation, for example. Fragmentation is defined as the breaking down or degradation of the substance of interest into smaller particles which can be ions or neutral compounds. Graph 400 comprises graphs 402 and 404. Graph 402 shows data with a fragmentation alteration stage of a DMS system off, and graph 404 shows data with the fragmentation alteration stage of the DMS system enabled. The horizontal axis 406 of graphs 402 and 404 is compensation voltage with a range from −15V to 5V. The vertical axis 408 of graphs 402 and 404 is intensity with a range from about 0.55 to about 0.75. In graph 402, intensity of ethylene glycol dinitrate (EGDN) 410 and intensity of an interfering substance, interference 412, at specific compensation voltages 406 are difficult to resolve from each other. When a fragmentor is enabled, as shown in graph 404, intensity of the fragment of EGDN 414 and intensity of an interfering substance, interference 416, are easily distinguishable from each other. The difference between the intensity lines of EGDN 410 and fragment of EGDN 414 and the intensity lines of interference 412 and 416 show the benefits of alteration stages in DMS systems. If the intensity of EGDN 410 cannot be distinguished from the intensity of interference 412, as shown in graph 402, the result is a false alarm from interference 412. Graph 404 shows the intensity of the fragment of EGDN 414 and the intensity of interference 416 as easily distinguishable from each other, and therefore, there is no false alarm. Alteration stages of DMS systems reduce the false alarm rate in explosives detection by producing, for example, graph 404 that clearly distinguishes intensities of substances from each other.

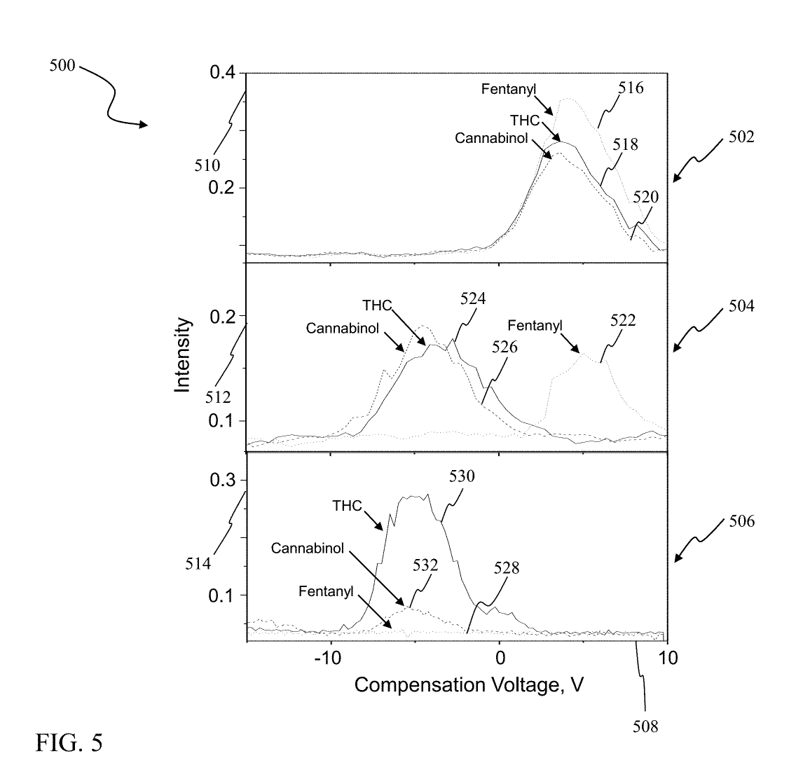

FIG. 5 is a graph 500 of intensity, expressed in arbitrary units versus compensation voltage, expressed in Volts (V), for narcotics detection in, for example, exemplary DMS system 100 shown in FIG. 1 and FIG. 2. Intensity versus compensation voltage is graphed, for example, using a collected charge from the mixture of ion species of the last DMS stage of DMS system 100 incident on detector 106. Alteration stages 206, 226, 234, and 236 between DMS stages 202, 204, 228, 230, and 232 may include reagent regions, for example. Graph 500 comprises graphs 502, 504, and 506. Graph 502 shows data from a DMS system with no reagent regions, and graphs 504 and 506 show data from a DMS system with differing reagent regions. The horizontal axis 508 of graphs 502, 504, and 506 shows compensation voltage with a range from about −15V to 10V. The vertical axes 510, 512, and 514 of graphs 502, 504, and 506, respectively, show intensity with ranges from about 0.1 to 0.4, about 0.05 to about 0.25, and about 0 to about 0.35, respectively. In graph 502, intensities of fentanyl 516, THC 518, and cannabinol 520 at specific compensation voltages (V) 508 are difficult to resolve from each other. In graph 504, when ions formed in an ion source are mixed with isopropyl alcohol (IPA) so that the concentration of IPA in gas flow 108 is approximately 0.1%, there is a better separation of the intensities of Fentanyl 522, THC 524, and Cannabinol 526. The intensity of fentanyl 522 can be easily distinguished from the intensities of THC 524 and Cannabinol 526. However, all intensities of substances should be easily distinguishable from each other so that each substance can be identified. In graph 506, when ions formed in an ion source are further mixed with an additional reagent 2-butanol at 1.5% in a different stage of a DMS system, the intensities of THC 530 and Cannabinol 532 are easily distinguishable because the Cannabinol signal is suppressed and the Fentanyl intensity 528 becomes almost zero. The difference between the intensities of Fentanyl 516, 522, and 528, THC 518, 524, and 530, and Cannabinol 520, 526, and 532 show the benefit of alteration stages in, for example, DMS system 100. The incorporation of both reagents into the ion flow of different stages of a DMS system leads to the proper identification of Fentanyl, THC, and Cannabinol in graphs 504 and 506. Alteration stages of DMS systems lead to correct contraband identification in narcotics detection by producing, for example, graphs 504 and 506 that clearly distinguish intensities of substances from each other.

FIG. 6 illustrates an exemplary process for determining filtering conditions for different DMS stages described above, in accordance with some embodiments of the present specification. Preferably, the instrument conditions for filtering ions would be determined and optimized by the manufacturer and implemented into the library accordingly. The conditions will be applied automatically afterwards, as programmed into the configuration.

At 602, analytes and interferences are introduced in to the system, such as system 100 in accordance with some embodiments. Analytes and interferences are introduced as charge neutral compounds into the system (602) during sampling. In the system, the molecules would then be ionized by the ionization source (102).

At 604, a first survey scan is performed for each DMS stage. The survey scan comprises varying at least one of waveform amplitude of a separation voltage (Sᵥ), type of waveform of the Sᵥ, frequency of the Sᵥ, temperature of the analytical gap within each DMS stage, moisture within the analytical gap of each DMS stage, flow rate, or any other experimental parameters that govern the mobility or differential mobility of ions within each DMS stage and therefore the ability to separate them in the DMS stages parameter.

Controller 114 is configured to be able to modulate the governing variables of each parameter. At 606, specific Sᵥ and compensation voltage (Cᵥ) are modulated, surveyed, and recorded for the various combinations of parameters at each DMS stage. At 608, a check is performed to determine whether the desired selectivity has been obtained. If the desired selectivity level has not been obtained, the modulation or survey is repeated at 606 until the successful operational conditions are found for operating the system 100. Referring to FIG. 6, different filtering conditions, such as waveform amplitude, type or frequency, temperature, moisture or flow rate, are modified and applied in a predefined sequence (such as first varying waveform amplitude then temperature then moisture then flow rate). The controller scans Sᵥ and/or Cᵥ for the first stage and records under which set of parameters ions are transmitted through the first stage of the drift tube. The desired level of selectivity is achieved for a known challenge, for example a sample plus an interferent, if a set of conditions, such as waveform amplitude, type or frequency, temperature, moisture or flow rate, (utilizing one or multiple segments) are found under which ions generated from sample and ions from the interferences have different Sᵥ and Cᵥ combinations for detection. Parameters may vary for each stage. Referring to FIG. 2, each of the individual sections of the drift tube may be operated under different parameters to yield varied Sᵥ and Cᵥ combinations. These stages may be part of one or several drift tubes while the drift conditions may vary in each stage.

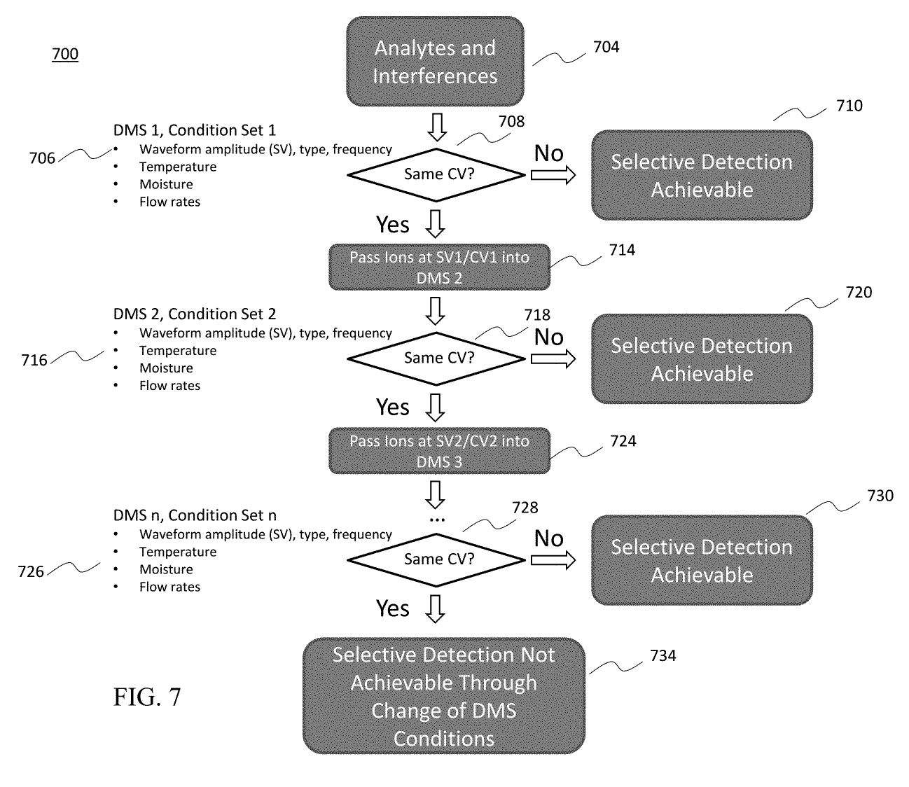

FIG. 7 illustrates an exemplary process 700 of determining whether selective detection may be achieved by varying parameters within each DMS stage, as described above and in accordance with some embodiments of the present specification. Analytes and interferences are inputted into the system 704 and a set of fragmentation conditions, such as waveform amplitude, type or frequency, temperature, moisture or flow rate, are applied at each of a plurality of stages 706, 716, 726. Compensation voltage(s) and/or separate voltage(s) are determined after each of the plurality of stages 708, 718, 728 and compared to determine if they are the same or their relative values. Where Cv is the same, that means, for a given set of conditions (e.g. condition set 1), the same compensation voltage would also be needed under condition set 2 to let ions pass and reach the detector plate where they would generate a detection signal 714, 724, 734. Where Cv is not the same, selective detection is determined to be achievable 710, 720, 730. If it is determined that a selective detection is achievable 710, 720, 730, then the set of corresponding fragmentation parameters are recorded, programmed into a library which is stored in an electronic database or table, and made available for future retrieval in order to use those parameters for detection. The fragmentation conditions become detection criteria that would need to be applied in order to achieve an effective alarm. The number of stages that would need to be implemented depends on the complexity of the sample and on the nature of the application, including any physical size, weight, or electronic limitations.

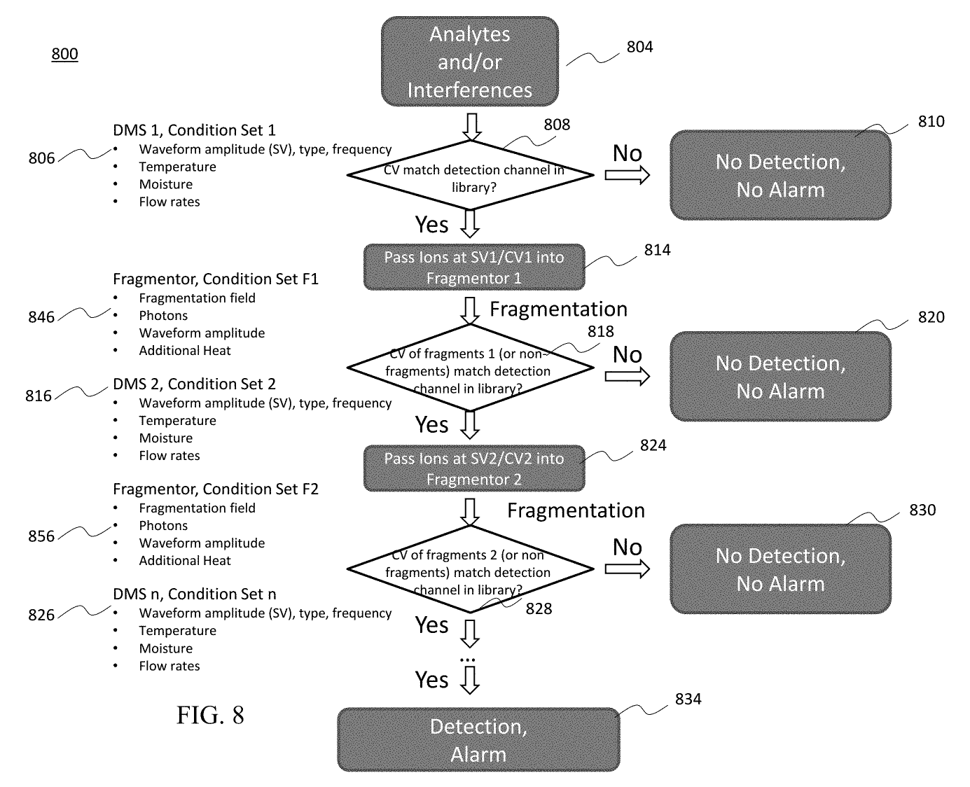

FIG. 8 illustrates another exemplary process in accordance with some embodiments of the present specification. The purpose of this process is very similar to that of the process described in FIG. 7, but includes a potential fragmentation step, along with a comparison to stored data in the library to determine an alarm. Analytes and interferences are inputted into the system 804 and a set of fragmentation conditions, such as waveform amplitude, type or frequency, temperature, moisture or flow rate, are applied at each of a plurality of stages 806, 816, 826. Compensation voltage(s) and/or separate voltage(s) are determined after each of the plurality of stages 808, 818, 828 and compared to a detection channel in a database or library. “Detection channel” in library refers to information in the database to which the measurement is compared. If the results from the current measurement and the results entered into the library match sufficiently, the result may fulfill the detection criteria for an alarm. More specifically, where Cv matches a detection channel, ions are passed to a subsequent stage and a fragmentation step may be applied in accordance with at least one or more stages 846, 856 which modifies ions and thereby provide another mechanism of characterization. Ion modification may be achieved by modulating a fragmentation field, applying photons, increasing temperature, or modifying waveform amplitude 846, 856. Where ions pass through all of the stages, the controller may detect the ions and actuate an alarm 834. The more detection criteria the ions have to fulfill in order to alarm, the more confident the system can be that a match is a true alarm and the more likely false alarms are filtered out. Where Cv does not match detection channels in the library, the controller may determine there is no detection and, accordingly, no actuation of an alarm 810, 820, 830.

An exemplary technical effect of the methods, systems, and apparatus described herein includes at least one of: providing multiple sequential DMS stages operating with distinct compensated asymmetric electric fields; improving selectivity and resolving power of the DMS system by utilizing the multiple sequential DMS stages; characterizing mixtures of ion species utilizing multiple sequential DMS stages with or without chemical or physical alteration of ions between pairs of sequential DMS stages; improving resolving power and selectivity of a DMS system without additional cost, complexity, power, and bulk of combinations with DMA, ion mobility spectrometry, gas chromatography, mass spectrometry or other spectrometry or analyzing equipment; providing a compact, low power, and mobile DMS system with good resolving power and selectivity for narcotics, explosives, and other substances of interest; and reducing false alarm rates and improving confidence in characterization and detection of narcotics, explosives, and other substances of interest.

Exemplary embodiments of methods, systems, and apparatus for DMS systems are not limited to the specific embodiments described herein, but rather, components of systems and/or steps of the methods may be utilized independently and separately from other components and/or steps described herein. For example, the methods may also be used in combination with other non-conventional DMS systems, and are not limited to practice with only the systems and methods as described herein. Rather, the exemplary embodiment can be implemented and utilized in connection with many other applications, equipment, and systems that may benefit from increased efficiency, reduced operational cost, and reduced capital expenditure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A multi-stage differential mobility spectrometer (DMS), comprising:
a chamber through which a flow of ions travels from a first end toward a second end opposite the first end, said chamber comprising:
a plurality of DMS stages, comprising:
a first DMS stage configured to generate a first compensated asymmetric electric field therein to separate a mixture of ion species from the flow of ions generated in an ion source;
a second DMS stage configured to generate a second compensated asymmetric electric field therein to separate a second mixture of ion species resulting from filtering of some ion species by the first DMS stage; and
at least one detector disposed at the second end of said chamber, said detector configured to collect a charge of ion species exiting from a last DMS stage, and generate a characteristic signal representative of ion species exiting the last DMS stage and incident on said detector.

2. The multi-stage DMS of claim 1 further comprising an ionization source disposed at the first end of said chamber and configured to:
receive a sample of a substance of interest;
generate ions from the sample; and
direct the generated ions into the first DMS stage of said multi-stage DMS.

3. The multi-stage DMS of claim 2, wherein said ionization source is further configured to:
receive at least one of a reagent and a dopant; and
generate the ions from the sample and at least one of a reagent and a dopant.

4. The multi-stage DMS of claim 1, wherein said chamber further comprises at least one alteration stage disposed between any pair of adjacent DMS stages, said alteration stage configured to:
receive the pre-filtered ion population from the preceding DMS stage of the adjacent DMS pair in said chamber;
perform at least one of a chemical and a physical alteration on the ion population, thereby producing altered ions from the ion population pre-filtered by at least one preceding DMS stage; and
direct the altered ions into said subsequent DMS stage of said DMS pair within said multi-stage DMS.

5. The multi-stage DMS of claim 4, wherein said alteration stage comprises at least one fragmentor configured to dissociate ion populations pre-filtered by preceding DMS stages.

6. The multi-stage DMS of claim 4, wherein said alteration stage comprises at least one mixing chamber into which a predetermined concentration of a dopant is injected to a mixture of ions emerging from the DMS stage preceding a mixing chamber.

7. The multi-stage DMS of claim 1, wherein said first DMS stage comprises first and second electrodes that define an analytic gap there between and through which the flow of ions passes, said first and second electrodes configured to create the first compensated asymmetric electric field, including a separation field defined as a function of a separation voltage applied transversely on at least one of said first and second electrodes, and a compensation field defined as a function of a compensation voltage applied transversely on at least one of said first and second electrodes.

8. The multi-stage DMS of claim 7 further comprising voltage generators operated by a controller and coupled to corresponding electrodes of respective DMS stages, said voltage generators configured to:
generate waveforms with changing amplitude such that characteristic oscillation between low and high field strength is realized; and
generate at least one compensation voltage signal that sweeps over at least one of a predetermined range of compensation voltages and a set compensation voltage corresponding to the compensation field for a mixture of ion species.

9. The multi-stage DMS of claim 1 configured to be integrated with at least one of an ion mobility spectrometry (IMS) apparatus and an ion trap mobility spectrometry (ITMS) apparatus, wherein the IMS and ITMS apparatuses may be placed before or after the multi-stage DMS and allow for additional ion characterization in an integrated apparatus.

10. The multi-stage DMS of claim 1 configured to be integrated with a mass spectrometer of a selected type, wherein the mass spectrometer is placed after the multi-stage DMS and allows for additional characterization of ions emerging from the last stage of the multi-stage DMS.

11. The multi-stage DMS of claim 1 configured to be integrated with a separation apparatus based on at least one of gas and liquid chromatography methods or capillary electrophoresis, said separation apparatus is configured to perform sample pre-fractionation and is placed in front of multi-stage DMS.

12. A method of conducting multi-stage differential mobility spectrometry, said method comprising:
receiving a flow of a plurality of ions at a first differential mobility spectrometer (DMS) stage;
generating a first compensated asymmetric electric field within the first DMS stage to separate a first population of ion species from the flow of the plurality of ions, the first compensated asymmetric electric field corresponding to the first stage of selecting ion species;
receiving the selected ion species at a second DMS stage;
generating a second compensated asymmetric electric field within the second DMS stage to separate ion species selected in the first DMS stage, the second compensated asymmetric electric field corresponding to the second stage of selecting ion species; and
collecting a charge of ion species emerging from a last DMS stage of multi-stage DMS on detectors.

13. The method of claim 12 further comprising generating a characteristic signal representative of multiple steps of ion filtering in different DMS stages of a multi-stage DMS chamber.

14. The method of claim 12 further comprising performing at least one of a chemical alteration and a physical alteration on the selected population of ion species after the selected population of ion species exit a selected DMS stage and before the selected population of ion species enters the subsequent DMS stage.

15. The method of claim 14, wherein performing the at least one of a chemical alteration and a physical alteration comprises introducing a predetermined concentration of a dopant to the selected population of ion species.

16. The method of claim 14, wherein performing the at least one of a chemical alteration and a physical alteration comprises dissociating the first selected population of ion species.

17. The method of claim 12, wherein generating the first compensated asymmetric electric field within a stage of multi-stage DMS comprises:
applying a separation voltage across first and second electrodes of the DMS stage to generate a separation field; and
applying a compensation voltage across the first and second electrodes to generate a compensation field that augments the separation field, thereby generating the first compensated asymmetric electric field.

18. The method of claim 17, wherein applying a compensation voltage across the first and second electrodes comprises sweeping a voltage applied across the first and second electrodes through a range of compensation voltages corresponding to the specific characteristics of ion species present in the stage of multi-stage DMS.

19. The method of claim 12, wherein the flow of the plurality of ions includes the selected ion species and may include at least one population of unselected ion species.

20. The method of claim 19, wherein generating the first compensated asymmetric electric field within the first DMS stage further comprises directing the first selected population of ion species through a selected DMS stage toward the subsequent DMS stage along a path of the flow of the plurality of ions.

21. The method of claim 20, wherein generating the first compensated asymmetric electric field within the selected DMS stage further comprises displacing the at least one unselected ion species in a direction transverse to the flow of the plurality of ions and toward one of a first electrode and a second electrode of the selected DMS stage.

22. The method of claim 21 further comprising neutralizing the at least one unselected ion species upon contact with one of the first electrode and the second electrode of the selected DMS stage.
